(19) United States
(12) Patent Application Publication
(10) Pub. No.: US 2009/0095136 A1
(43) Pub. Date: Apr. 16, 2009

(54) SELF ACTIVATING TORQUE TOOL

(75) Inventor: Maurice William Slack, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: NOETIC TECHNOLOGIES INC., Edmonton (CA)

(21) Appl. No.: 12/253,119

(22) Filed: Oct. 16, 2008

Related U.S. Application Data
(60) Provisional application No. 60/980,395, filed on Oct. 16, 2007.

(51) Int. Cl. B25B 17/00

(52) U.S. Cl. 81/57.39

(57) ABSTRACT

A self actuating torque tool includes a shoe having at least one guide track lying in a plane, and at least one jaw. Each jaw has a follower paired with a pivot axis normal to the plane of the guide track. The follower travels along the at least one guide track between an extended position and a retracted position. There is a drive coupling through which torque is applied to the shoe. One of left torque or right torque is applied to the drive coupling causing the follower to travel along the at least one guide track moving the jaw to the extended position, and another of left torque or right torque is applied to the handle causing the follower to travel along the at least one guide track moving the jaw to the retracted position.

### FIELD

Self activating tools, such as pipe wrenches.

### BACKGROUND

The threaded box (internally threaded) and pin (externally threaded) ends of tubulars such as casing or tubing, used to construct or complete wells, are often protected from damage during handling by threaded caps or sleeves, referred to here generally as thread protectors. These thread protectors are installed or removed by applying right or left hand torque. The means for applying torque can take the form of hand gripping the work piece, but usually requires some form of tool to engage the thread protector to provide sufficient torque or to improve efficiency, including safety. Where the thread protector has an exposed exterior cylindrical surface, numerous types of exterior gripping pipe wrenches are known in the art and are commercially available. In other instances, the thread protector may be provided with additional features such as notches on its exposed end to engage a tool, such as a simple cross bar or allowing a larger moment couple to be applied by hand manipulation of the cross bar than would be possible from simply gripping the thread protector. However it is not always possible or convenient to arrange for such means of engagement.

### SUMMARY

According to an aspect, there is provided a self actuating torque tool includes a shoe having at least one guide track lying in a plane, and at least one jaw. Each jaw has a follower paired with a pivot axis normal to the plane of the guide track. The follower travels along the at least one guide track between an extended position and a retracted position. There is a drive coupling through which torque is applied to the shoe. One of left torque or right torque is applied to the drive coupling causing the follower to travel along the at least one guide track moving the jaw to the extended position, and another of left torque or right torque is applied to the handle causing the follower to travel along the at least one guide track moving the jaw to the retracted position.

According to an aspect, there is provided is a self activating torque tool configured to grip a cylindrical contact surface of a work piece and enable transfer of right or left hand torque from the tool into the work piece where the grip force increases with applied torque. The tool is configured to grip the work piece through contact with two separate components, a shoe and a jaw, where the shoe is provided with a handle to manipulate the tool and through which torque is applied. The shoe and jaw are arranged to act in radial opposition to each other, through one of two fulcrums or axial pivots where, depending on the direction of rotation or torque applied to the handle, one fulcrum is active to apply left hand torque and the second active for right hand torque. The fulcrums are arranged so that when the tool is fully retracted both fulcrums are in contact. From this retracted position, and with the tool located coaxially in the plane of the work piece and placed with the jaw against the work piece cylindrical contact surface, the pivots are selectively positioned so that relative rotation of the shoe with respect to the jaw in either direction then allows the shoe to extend radially toward the work piece cylindrical surface until engaged, which radial engagement is reacted with a mechanical advantage controlled by the selective positioning of the pivots considering the friction coefficients present for the intended application, to thus result in the tool gripping the work piece, rather than sliding, and enable transfer of torque between the tool and work piece. Conversely, when the shoe is in the extended position, reversing the direction of rotation tends to retract and disengage the shoe from the work piece.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front perspective view of an internal gripping dual acting torque tool as it appears in the retracted position ready to engage a work piece.

FIG. 2 is a rear perspective view of the dual acting torque tool of FIG. 1.

FIG. 3 is a front elevation view of the dual acting torque tool of FIG. 1 inserted into the proximal end of a tubular work piece as it appears with left hand torque applied and engaged with the internal contact surface of the tubular work piece.

FIG. 4 is a rear elevation view of the dual acting torque tool of FIG. 3.

FIG. 5 is a partial cutaway front perspective view of the dual acting torque tool of FIG. 3.

FIG. 6 is a rear elevation view of the shoe/handle assembly of the dual acting torque tool of FIG. 1.

FIG. 7 is a front perspective view of the shoe/handle assembly of FIG. 6.

FIG. 8 is a front perspective view of the jaw/guide-pin assembly of the dual acting torque tool of FIG. 1.

FIG. 9 is a front elevation view of the torque tool of FIG. 3 provided with a second guide-pin and slot as it appears with left hand torque applied and engaged with the internal surface of a tubular work piece.

FIG. 10 is a front view of the external gripping dual acting torque tool provided with an open jaw architecture as it appears with right hand torque applied and engaged with the external contact surface of a tubular work piece.

### DETAILED DESCRIPTION

In a preferred embodiment, the torque tool is configured to grip an internal cylindrical contact surface close to the proximal end of a work piece, where the jaw has a plane of symmetry between the two pivot centres and is shaped to have two points or regions of engagement, on either side of the symmetry plane, when placed within and against an internal work piece contact surface, and is constrained to stay in the same radial plane as the shoe using suitable means such as one or more retaining guide pins attached to the jaw and moving in slots provided in the shoe with attached handle assembly, where the retaining guide pins and slots are placed to allow free relative rotation of the shoe about either pivot. The shoe is provided with a curved shoe contact surface having a radius of curvature selected to be less than that of the work piece contact surface and curvature centre offset with respect to both pivot locations providing a double acting eccentric cam action upon relative rotation. With this configuration rotation of the handle causes the shoe to either extend into engagement with the work piece at a third region of contact, on the shoe contact surface, or conversely to retract, depending on the direction of rotation and the relative rotational position between the jaw and shoe. The three points of contact with the work piece thus provided are arranged to be spaced at approximately third points of the contact surface circumference, which loading geometry results in less tendency to deform the work piece than would two points of contact.

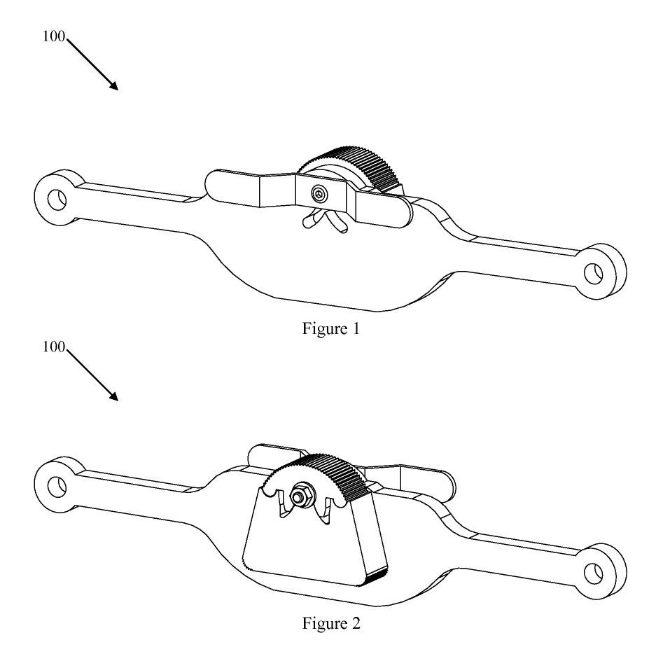

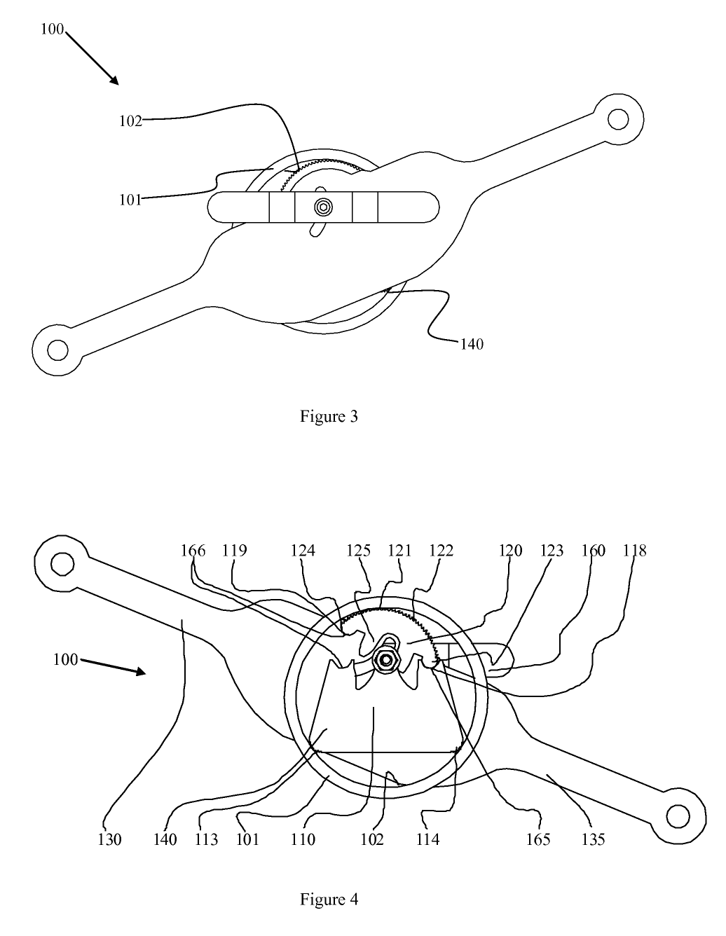

Referring to FIG. 1 and 2, this internally gripping preferred embodiment of the self activating torque tool, is generally referred to by the numeral 100, is shown in front and back perspective views respectively, where the torque tool 100 is shown as it appears in the retracted position, ready to engage a work piece (not shown). While illustrated torque tool 100 is depicted as a male engagement that is designed to engage the interior surface of a work piece, it will be understood that suitable modifications may be made to allow it to engage the exterior surface of a workpiece as a female engagement, for example as shown in FIG. 10. Furthermore, in the discussion below, the terms “retracted” and “extended” refer to the proximity of the jaw to the surface being engaged. Referring now to FIG. 3 and 4, self activating torque tool 100 is shown in front and back views respectively as it appears with left hand torque applied and engaged with internal contact surface 102 of tubular work piece 101. The torque tool 100, which is configured to apply torque in either direction as depicted, has jaw/guide-pin assembly 140. It will be understood that torque tool 100 may equally be designed to apply torque in a single direction. However, the depicted embodiment allows the tool to be more versatile.

Referring now to FIG. 8, jaw/guide-pin assembly 140 is provided with a rigid jaw 110 generally provided as a rigid plate having parallel front and back faces 115 and 116 and shaped about a plane of symmetry to have two bottom jaw edge contact regions 111 and 112 and top edge face 117 provided with two pivots 118 and 119. Jaw contact regions 111 and 112 carry curved jaw contact surfaces 113 and 114 provided here with a coarse roughened tooth profile, typical of pipe wrench dies, which profiled surface may be hardened to increase effective friction coefficient and improve wear characteristics as is known to the art. Retaining guide-pin 150, is rigidly attached to jaw 110 on its line of symmetry so as to extend outward normal to front face 115.

Referring again to FIG. 4, shoe 120 is also provided as a rigid plate generally corresponding in thickness to rigid jaw 110 where bottom edge surface 125 of shoe 120 is profiled to have a shape that is generally close fitting with top face 117 of jaw 110.

The lower end 154 of retaining guide pin 150 contains a thread element which threadingly engages with retaining nut 180. Guide pin 150 is assembled coaxially with and internal to guide pin hole 156 in jaw 110.

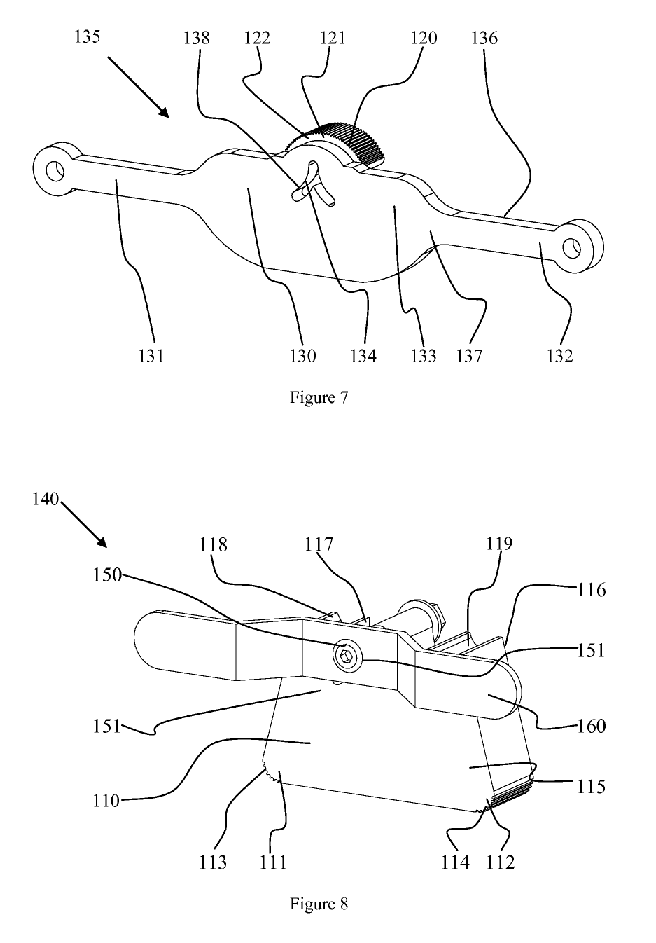

Referring now to FIG. 7, which shows a perspective view of shoe/handle assembly 135. Shoe 120 is provided with shoe contact surface 122. Referring now to FIG. 4, shoe contact surface 122 has region or point of contact 121 with internal contact surface 102 of work piece 101 which will vary depending on the diameter of internal contact surface 102. Referring now to FIG. 6, shoe contact surface 122 generally consists of a curved profile, in this case shown to be of constant radius where the radius of curvature is less then that of work piece 101 contact surface and the radius centre falls on the plane of symmetry line between pivots points 123 and 124. It is understood that it may be desirable to have the contact surface profile of a different shape, and that the design is not limited to a constant radius profile. More complex curved geometries may be used, for example, to increase diameter range and improve grip ratio. Referring again to FIG. 4, the jaw contact surfaces 113 and 114, the shoe contact surface 121 has a coarse profiled surface finish, typical of pipe wrench dies, which profiled surface may similarly be hardened to increase friction and improve wear characteristics as is known to the art. In this case the coarse profiled surface is comprised of axially oriented V-shaped grooves, which are biased symmetrically about the centerline in order to preferentially increase friction in the direction of contact loading.

Referring still to FIG. 4, the shoe 120 has two pivot points 123 and 124 at either end of bottom surface 125. Referring again to FIG. 7, shoe 120 is rigidly connected to generally elongate torque handle 130, with front face 136 and back face 137, and collectively form the shoe handle assembly 135. The torque handle 130 has two torque application arms 131 and 132 and central guide plate 133 containing dual arc guide slot 134 with smooth guide surface 138. Shoe 120 also has a corresponding curved guide track to allow a track follower 150 to pass through it. In some situations, it may be possible to integrally form torque handle 130 and shoe 120, such that shoe handle assembly 135 may be referred to be shoe 120. Thus, while shoe 120 may not have an inner surface to define both sides of track 134, it will be understood that torque handle 130 adds this feature to shoe 120. Referring now to FIG. 6, which shows a rear view of the shoe/handle assembly 135, the dual arc guide slot 134 is arranged such that it is symmetrical and forms an arc about the pivot points 123 and 124 on shoe 120, and that the arcs meet on the centre line axis of symmetry of the torque handle 130.

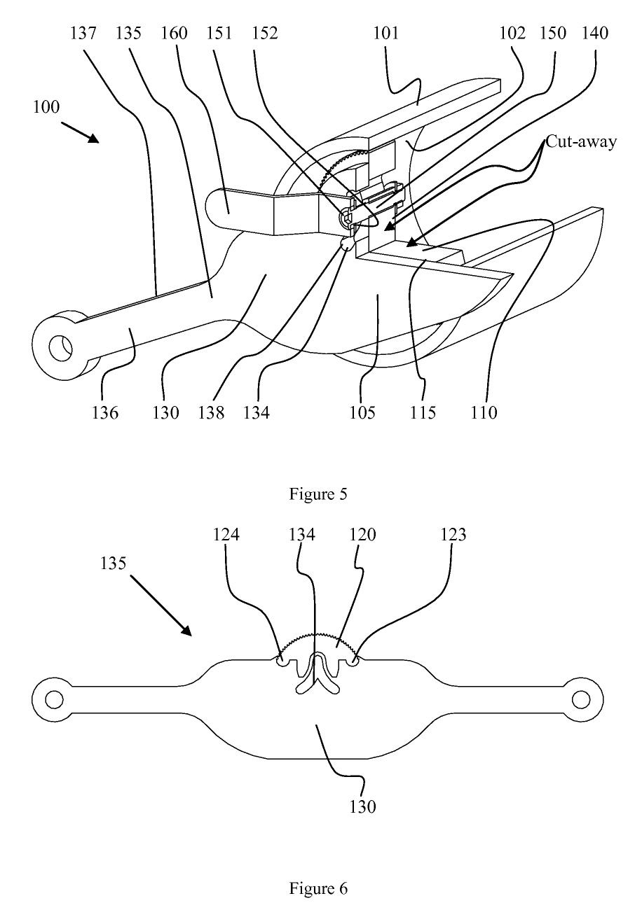

Referring now to FIG. 5, which shows a perspective partial cutaway view of self activating torque tool 100, as it appears assembled and engaged with the internal contact surface 102 of work piece 101. Shoe/handle assembly 135 and jaw pin assembly 140 are assembled such that the front face 115 of jaw 110 is slidingly engaged with back face 137 of torque handle 130, and guide pin, or follower, 150 is arranged to extend outward through guide slot 134, engage slidingly with guide surface 138, and engage with retaining nut 152 and lock nut 151. Activation handle 160 can be provided and clamped between lock nut 151 and retaining nut 152 which serves to lock activation handle 160 to guide pin 150. Referring now to FIG. 4, pivot 123 on shoe 120 is shown engaged with pivot 118 on jaw 110, collectively forming left hand pivot pair 165 while pivots 124 and 119, collectively forming right hand pivot pair 166 are disengaged as is expected with application of left hand torque to torque handle 130.

Referring again to FIG. 5, with the dual acting torque tool 100 assembled as described, the jaw/guide-pin assembly 140 and shoe/handle assembly 135 are allowed to move relatively free of one another with the exception of the retaining guide pin 150 being constrained to travel in the double arc guide slot 134. Referring now to FIG. 4, as torque is applied left hand pivot pair 165 or right hand pivot pair 166 engages to further constrain relative motion between the assemblies.

Referring again to FIG. 4, the position of shoe 120 relative to jaw 110 can be constrained with one or more retaining guide pins and slots where the torque tool 100 is provided with a tension spring (not shown) arranged to act between the jaw 110 and the shoe 120 tending to bias jaw 110 and shoe 120 together when no torque is applied and as such both pivot pairs 165 and 166 will initially be in engagement. This arrangement also serves to retract the jaw 110 once the applied torque is removed.

Referring now to FIG. 5, torque tool 100, may be provided with activation handle 160 which is rigidly attached to the retaining guide pin 150 which in this embodiment is rigidly attached to jaw 110. Activation handle 160 is located on the proximal side 105 of the torque tool 100, and designed so that when in use the lever 160 is easily accessible for hand manipulation. Referring now to FIG. 4, operationally the activation handle 160 is used by an operator to bring into engagement the contact surfaces 113 and 114 of jaw 110 and 122 of shoe 120, by allowing independent manual movement of the jaw/guide-pin assembly relative the shoe/handle assembly through forces applied to activation handle 160 as one means to enable rotation of jaw 110 relative to torque handle 130 to assist positioning during installation and initial activation of torque tool 100 in work piece 101. Once engaged with the internal contact surface 102 of work piece 101, application of torque to torque handle 130 will maintain contact and allow continued torque application in that direction. Application of torque in the reverse direction will release the tool, while continued application of reverse torque will subsequently set the tool in the reverse direction.

It will be understood that activation handle 160 and torque handle 130 are one means of setting and releasing torque tool 100. In this example, activation handle 160 initially sets torque tool 100 by causing shoe 110 and jaw 120 it to engage the workpiece. Thus, to set torque tool 100, it is necessary to move shoe 120 relative to jaw 110. This may be done by a drive coupling, a handle, etc. Once set, torque may then be applied to torque tool 100 and thus the workpiece by another separate drive coupling, handle, etc. In the depicted embodiment, bifurcated guide track 134 has a left torque leg and a right torque leg with corresponding left and right paired pivot axes. Left torque that is applied to shoe 120 by the applicable drive coupling or handle causes the follower 150 to travel along the left torque leg moving the jaw 110 toward the extended position, and right torque applied to the handle causes the follower 150 to travel back along the left torque leg, thus moving the jaw 110 toward the retracted position. Continued application of right torque causes the follower 150 to enter the right torque leg and travel along the right torque leg moving the jaw 110 toward the extended position and left torque applied to the applicable drive coupling or handle causing the follower 150 to travel back along the right torque leg moving the jaw 110 toward the retracted position. It will also be understood that there may be more than one guide track, and more than one follower provided to guide the relative movement of the jaw 110 and the shoe 120.

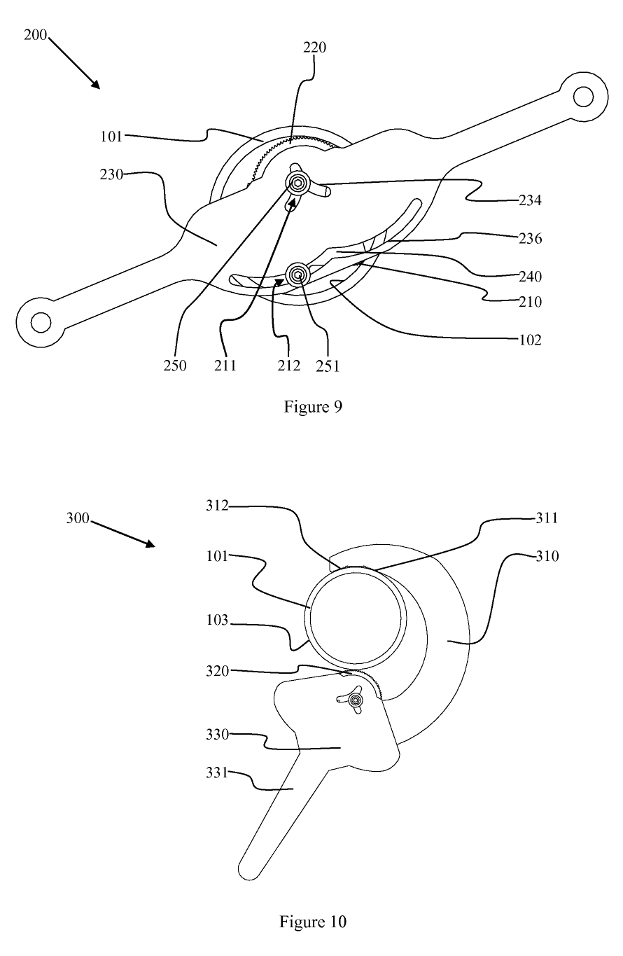

Referring now to FIG. 9, which shows an alternative embodiment of the self activating torque tool, generally referred to by the numeral 200 and shown as it would appear with left hand torque applied and engaged with the internal surface 102 of work piece 101. To maintain engagement of either of both pivot pairs, even when not loaded, it may be desirable in certain applications to provide the torque tool with a modified handle 230 which includes two double arc guide slots 234 and 236 which are suitably spaced with respect to the pivot points to prevent pivot disengagement throughout the allowed range of relative movement of jaw/guide-pin assembly 240 and shoe/handle assembly 235. In this embodiment the torque tool 200 is also provided with a modified jaw 210 that contains two guide pin assembly holes 211 and 212 located along the centerline axis of symmetry of the jaw. Torque tool 200 is provided with guide pins 250 and 251 which are assembled coaxially with and internal to guide pin assembly holes 211 and 212 respectively. The further constraint will ensure that when torque tool 200 is placed into a work piece 101 that the tool is aligned properly to immediately engage the work piece 101 regardless of the orientation of the shoe 220 and jaw 210 of torque tool 200.

Referring now to FIG. 10, which shows another alternate embodiment of the torque tool architecture, arranged as an externally gripping torque tool and generally referred to by the numeral 300. In this configuration the jaw 310 is configured with inward facing contact regions 311 and 312 (which can be reduced to a single region for certain applications). In this embodiment jaw 310 is shown to be generally C-shaped such that it can be used to grip the external surface of a tubular work piece anywhere along it's length, however, it is understood that the jaw can also be provided as a ring such the torque tool would have to be installed from an end of the work piece. The shoe 320 is located between the jaw 310 and work piece 101 and is urged radially inward under the action of relative rotation resulting from torque applied to handle 330. Handle 330 is arranged with a single arm 331 to avoid interference with the external surface 103 of work piece 101.

The effectiveness of the torque tool at gripping the work piece depends on the mechanical advantage or grip ratio of the tool. The grip ratio is governed by the minimum coefficient of friction required for the contact surfaces to stick, and as will now be evident to one skilled in the art, is a function of the contact point geometry and the position of the pivot points and so must be selected with reference to the expected friction coefficients present in a given application. In addition, the location of the pivot points also controls the range of sizes the torque tool can accommodate. It will thus be apparent to one skilled in the art that in the teachings described herein, the shoe geometry and pivot point locations may be adjusted to ensure satisfactory gripping characteristics through a specified range of tube diameters is maintained, where in general higher gripping is obtained at the expense of diameter range. Furthermore, depending on the needs of a given application symmetric action in both directions of rotation and loading need not be maintained so that it is not required for the pivot pins and contact surfaces to be provided about a plane of symmetry. The torque tool architecture may be readily optimized to meet the needs of numerous applications balancing limiting friction coefficient with diameter range and direction of rotation and enjoys the benefits of this flexibility while also offering bi-directional torque application at more than two regions of contact loading with the work piece offering the further advantage of reduced work piece distortion when applying torque.

In the preferred embodiment, the range of internal diameters that can be gripped with a single tool is limited for sake of simplicity to an architecture where the jaw is non-adjustable. However, the torque tool is not limited to this architecture as it may be desirable to increase the available gripping range of a single tool in order to limit the number of tools required to apply torque to multiple sizes of pipe. As such the jaw can be provided as an assembly with adjustable positioning of jaw contact regions 111 and 112. Similarly the shoe can be provided as an adjustable assembly to adjust the positioning of shoe contact surface 122.

Although the preferred embodiment can apply torque in both directions, for certain applications it may be desirable to provide a tool that is limited to torque application in a single direction. To accommodate this requirement, the torque tool can be provided with a single pivot, which may be fixed, one or more single arc guide slots, and modified grip tooth geometry optimized to grip in only one direction.

Further, while the preferred embodiment anticipates applications where the handle can be located immediately outside the proximal end of the work piece, in an alternate embodiment the handle can be extended to accommodate applications where the work piece contact surface is located deeper inside a tube or where access at the proximal end is restricted as for example where the thread protectors must be removed from a pipe joint on a rack of closely spaced pipe where the pipe end is inset with respect to the pipe ends of adjacent pipes.

While the preferred embodiment has been described as a hand operated torque tool, the torque tool can also but used in applications employing mechanized manipulation.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. A self actuating torque tool, comprising:
a shoe having at least one guide track lying in a plane;
at least one jaw, each jaw having a follower paired with a pivot axis normal to the plane of the guide track, the follower travelling along the at least one guide track between an extended position and a retracted position; and
a drive coupling though which torque is applied to the shoe, one of left torque or right torque applied to the drive coupling causing the follower to travel along the at least one guide track moving the jaw toward the extended position and another of left torque or right torque applied to the drive coupling causing the follower to travel along the at least one guide track moving the jaw toward the retracted position.

2. The self actuating torque tool of claim 1, wherein the at least one guide track is bifurcated having a left torque leg and a right torque leg with corresponding left and right paired pivot axes, left torque applied to the drive coupling causing the follower to travel along the left torque leg moving the jaw toward the extended position and right torque applied to the drive coupling causing the follower to travel back along the left torque leg moving the jaw toward the retracted position, continued application of right torque causing the follower to enter the right torque leg and travel along the right torque leg moving the jaw toward the extended position and left torque applied to the drive coupling causing the follower to travel back along the right torque leg moving the jaw toward the retracted position.

3. The self actuating torque tool of claim 1, wherein there is more than one guide track, including a first guide track which interacts with a first follower and a second guide track that interacts with a second follower.

4. The self actuating torque tool of claim 1, wherein biasing means are provided to maintain the jaw in the retracted position until torque is applied to the shoe through the drive coupling.

5. The self actuating torque tool of claim 1, wherein the guide track defines a curved path.

6. The self actuating torque tool of claim 1, wherein the shoe has a male engagement surface for insertion into a workpiece.

7. The self actuating torque tool of claim 1, wherein the shoe has a female engagement surface for receiving a workpiece.

8. The self actuating torque tool of claim 1, wherein the drive coupling is a handle.

9. A self actuating torque tool, comprising:
a shoe having a guide track lying in a plane;
a jaw having a follower paired with a pivot axis normal to the plane of the guide track, the follower travelling along guide track to move the jaw between an extended position and a retracted position; and
a handle serving as a drive coupling though which torque is applied to the shoe, one of left torque or right torque applied to the drive coupling causing the follower to travel along the guide track moving the jaw toward the extended position and another of left torque or right torque applied to the handle causing the follower to travel along the guide track moving the jaw toward the retracted position.

10. The self actuating torque tool of claim 9, wherein biasing means are provided to maintain the jaw in the retracted position until torque is applied to the shoe through the handle.

11. The self actuating torque tool of claim 9, wherein the guide track defines a curved path.

12. The self actuating torque tool of claim 9, wherein the shoe has a male engagement surface for insertion into a workpiece.

13. The self actuating torque tool of claim 9, wherein the shoe has a female engagement surface for receiving a workpiece.

14. A self actuating torque tool, comprising:
a shoe having a guide track lying in a plane, the guide track being bifurcated with a left torque leg and a right torque leg with corresponding left and right paired pivot axes;
a jaw having a follower paired with a pivot axis normal to the plane of the guide track, the follower travelling along the guide track to move the jaw between an extended position and a retracted position; and
a handle serving as a drive coupling though which torque is applied to the shoe, left torque applied to the handle causing the follower to travel along the left torque leg moving the jaw toward the extended position and right torque applied to the handle causing the follower to travel back along the left torque leg moving the jaw toward the retracted position, continued application of right torque causing the follower to enter the right torque leg and travel along the right torque leg moving the jaw toward the extended position and left torque applied to the handle causing the follower to travel back along the right torque leg moving the jaw toward the retracted position.

15. A self actuating torque tool, comprising:
a shoe having a first guide track and a second guide track lying in a plane;
a jaw having a first follower and the second follower, where the first follower interacts with the first guide track and is paired with a first pivot axis normal to the plane of the first guide track and the second follower interacts with the second guide track and is paired with a second pivot axis normal to the plane of the second guide track, the first follower travelling along the first guide track and the second follower travelling along the second guide track to move the jaw between an extended position and a retracted position; and a handle serving as a drive coupling though which torque is applied to the shoe, one of left torque or right torque applied to the drive coupling causing the first follower to travel along the first guide track and the second follower to move along the second guide track moving the jaw to the extended position and another of left torque or right torque applied to the handle causing the first follower to travel along the first guide track and the second follower to move along the second guide track moving the jaw to the retracted position.
